(19) United States
(12) Patent Application Publication
(10) Pub. No.: US 2005/0147140 A1
(43) Pub. Date: Jul. 7, 2005

(54) Integrated laser cavity with transverse flow cooling

(76) Inventor: Stephen R. Aiken, Huntsville, AL (US)

Correspondence Address: Kermit D. Lopez;Ortiz & Lopez, PLLC, P.O. Box 4484, Albuquerque, NM, 87196-4484, US

(21) Appl. No.: 11/029,439

(22) Filed: Jan. 5, 2005

Related U.S. Application Data
(60) Provisional application No. 60/534,643, filed on Jan. 6, 2004.

(51) Int. Cl. H01S 3/04

(52) U.S. Cl. 372/35

(57) ABSTRACT

A laser cavity includes two half shells adapted to be held together forming a sealed, integrated laser structure. The laser cavity is adapted for retaining an excitation source and a lasing medium. At least one coolant passage formed in at least one of the half shells causes liquid to flow transversely over the excitation source and lasing medium. At least one coolant passage formed in at least one of the half shells removes liquid from the laser cavity after the liquid is caused to flow transversely over the excitation source and lasing medium. An inlet formed in at least one of the two half shells can transport liquid into the laser cavity and through the coolant passages. An outlet formed in at least one of the two half shells can remove coolant from the laser cavity after the liquid is caused to flow transversely over the excitation source and lasing medium.

### PRIORITY

This application is a Continuation of Provisional Application No. 60/534,643, entitled “Integrated laser cavity with transverse flow cooling,” which was filed on Jan. 6, 2004, and to which priority is claimed.

### BACKGROUND

The present invention is related to a handheld laser head for medical and industrial laser applications. More particularly, the present invention is related to a handheld laser head for medical and industrial laser applications including a liquid cooling chamber for maintaining continuous laser operation.

Medical lasers, such as those used for skin resurfacing, wrinkle removal, tattoo removal and surgery generally include laser excitation sources such as flash lamps that generate much heat within the laser housing and therefore require cooling to prevent flash lamp failure. Liquid is well known to be used as a coolant within laser cavities wherein a flash lamp is operating. For example, U.S. Pat. No. 5,970,983 issued to Kami, teaches a solid cylindrical reflector tube for-increased optical pump efficiency. Toepel (U.S. Pat. No. 5,548,604), further teaches a liquid cooled medical laser with separate, multi-element end caps for precise positioning of the rod and flash lamp within a contiguous reflector tube, and end reflectors. Toepel also specifically teaches a longitudinal coolant flow with “folded” reverse flow back over the reflector tube and multi-element end caps which provide lamp/rod alignment and retention.

Multiple gaskets are used as seals for liquid coolant by sealing the cavity. Longitudinal coolant flow in the Toepel invention incurs a linear increase of coolant temperature down the longitudinal axis of the laser medium which contributes to undesirable thermo-optical distortions of that medium and further instills flow turbulences at mechanical frequencies strongly connected to the mechanical resonances of the laser medium and pumping elements.

Unfortunately, in addition to the noted multi-element assemblies and thermal/mechanical issues associated with the prior art, such laser systems are further found to be inefficient in heat removal, difficult to manufacture and subject to coolant leakage because of their designs. Flash lamps will either fail or be inefficient because of inadequate cooling, or a lasing system will experience misalignment over the laser resonator due to non-uniform cooling and/or liquid flow induced vibrations. A plurality of sealing gaskets or O-rings meant to seal a housing and reduce vibration physically increases the opportunity for coolant leakage and system complexity.

Based on the foregoing, the present inventor has concluded that improved system designs are needed that incorporate more efficient liquid cooling technology, simplified mechanical structures, and a more robust design.

### SUMMARY OF THE INVENTION

The following summary of the invention is provided to facilitate an understanding of some of the innovative features unique to the present invention, and is not intended to be a full description. A full appreciation of the various aspects of the invention can be gained by taking the entire specification, claims, drawings, and abstract as a whole.

In accordance with features of the preferred embodiment, a handheld laser cavity head using a quasi-monolithic housing for the laser excitation source and the lasing medium targeted at medical and/or industrial applications requiring small and portable laser apparatus is described.

It is feature of the embodiment for a housing to integrate the optical coupling chamber, coupling chamber end reflectors, laser excitation source and lasing medium into a simplified structure.

In accordance with another feature, two monolithic laser cavity half shells and a single coolant gasket seal provide coolant sealing of the laser cavity head.

In accordance with another feature, a molded seal gasket is used to create a liquid seal between the two half shells and laser components contained within the cavity formed by the two half shells when assembled.

It is yet another feature to yield a uniform coolant temperature across the lamp and laser rod because the flow direction is transverse as compared to a longitudinal coolant flow method. With longitudinal coolant flow, the coolant temperature rises linearly as it flows down the longitudinal axis of the lasing medium and excitation source. By eliminating this gradient with transverse flow, increased laser resonator alignment stability can be provided.

It is yet another feature to increase coolant flow rates through an increase of the internal coolant passage cross sectional area, while maintaining an overall compact laser structure. Cooling capacity can thus be increased for removal of heat from the laser excitation source.

In accordance with another feature, two cavity half shells include the optical coupling element, which has a optimal cross-section for laser excitation (e.g. cylindrical, elliptical, etc.) and can include the contoured ends appropriate to the specific laser medium used (e.g., solid state crystal rod, etc.). This design is adaptable to allow the optical coupling element to include a variety of cross sections with reflective or diffuse surface preparations (or a combination thereof) to optimally couple the laser excitation energy to the lasing media.

In accordance with yet another feature of the present invention, the coolant plenum can include a slot or multiple holes that directing the coolant to flow transverse (perpendicular) to the orientation of the flash lamp and rod. The slots or the holes that direct the coolant transversely can be tailored for either laminar or turbulent flow of the coolant to balance heat removal and optical coupling requirements (e.g., low flow induced opto-mechanical artifacts).

### BRIEF DESCRIPTION OF DRAWINGS

The accompanying figures, in which like reference numerals refer to identical or functionally-similar elements throughout the separate views and which are incorporated in and form part of the specification, further illustrate the present invention and, together with the detailed description of the invention, serve to explain the principles of the present invention.

FIG. 1 illustrates the overall laser cavity assembly in accordance with features of the present invention;

FIG. 2 illustrates the laser cavity coolant features in accordance with features of the present invention; and

FIG. 3 illustrates a laser cavity structure with slots or multiple holes in accordance with features of an alternate embodiment.

### DETAILED DESCRIPTION OF THE INVENTION

The particular values and configurations discussed in these non-limiting examples can be varied and are cited merely to illustrate an embodiment of the present invention and are not intended to limit the scope of the invention.

While the primary embodiment of the descriptions contained herein are illustrated by solid state crystal laser media (e.g. Er:YAG, etc.) excited or “pumped” by an electrical discharge through a flash lamp, it is to be understood that the disclosed concepts apply to, and include alternate laser media (e.g. dyes in cuvettes, quantum dot materials, etc.) and excitation sources (e.g. semiconductor diode lasers, etc.). To that extent terms such as “excitation source,” “pump,” “pump source” and “flash lamp” can be used interchangeably to designate sources of optical excitation for the laser media. Similarly, terms such as “laser media,” “lasing medium,” “laser rod,” “rod,” and “laser resonator” can also be used interchangeably are known as equivalent by those skilled in the art.

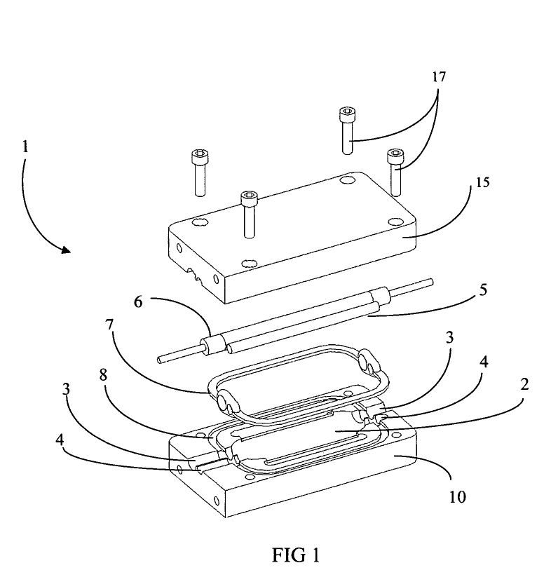

Referring to FIG. 1, a combined laser cavity and coolant mechanism 1 is formed by assembly of two laser cavity half shells 10 and 15. A first half shell 10 is constructed to precisely align the relative position of the lasing medium 5 and the laser excitation source 6. Grooves 3 and 4 formed in a surface of the half shell 10 align the excitation source and lasing medium respectively. The first half shell 10 also is constructed to include the optical coupling element 2 that couples the optical output from the excitation source into the lasing medium and also acts as a coolant plenum. The second half shell 15 also has grooves (not shown) and optical coupling element (not shown) that are formed on its surface that are complimentary to the grooves 3 and 4 and optical coupling element 2 formed on the surface of the first half shell 10.

A single gasket seal 7 can be positioned in the gasket groove 8 formed in the laser cavity structure 10, and also in a complimentary groove (not shown) formed in half shell 15, to provide sealing for liquid coolant when the cavity half shells 10 and 15 are assembled together. The half shells 10 and 15 can be held together with screws or bolts 17, although other means of holding the half shells 10 and 15 together can be utilized without limitation. The use of bolts 17 shown in FIG. 1 is not meant to narrow the embodiment.

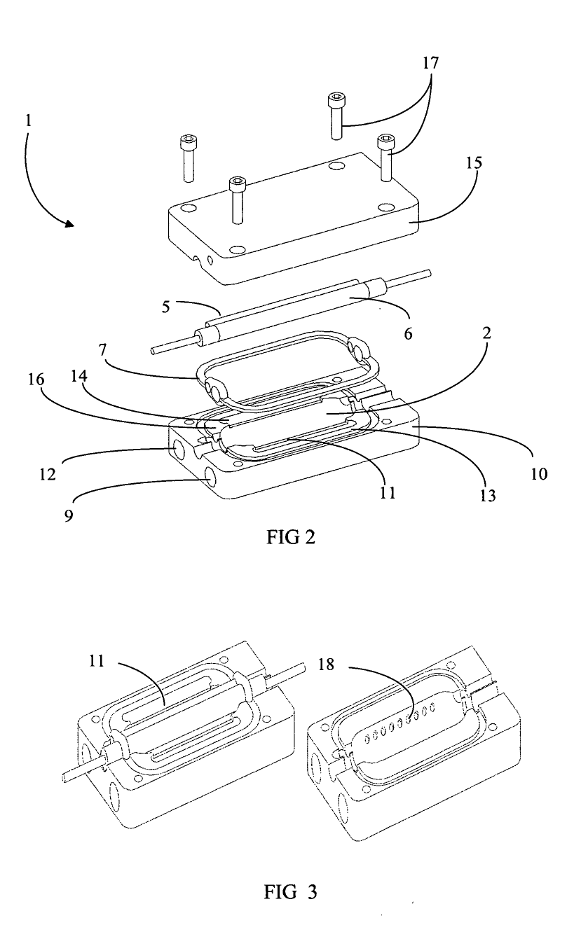

Referring to FIG. 2, during operation of the laser system 1 a coolant (not shown) flows into inlet 9 that can be formed in the side or end portion of one of the half shells 10 and 15 of the laser cavity structure 1. Inlet 9 is shown formed in the edge of the first half shell 10. Liquid entering the first half shell 10 then flows into the cavity through a first plenum 13 which is formed along the side of the cavity structure. A slot 11 formed along the length of the optical coupling element 2 allows the coolant to pass from the first plenum 13 into area formed by both-optical coupling elements formed in half shell 10 and 15. The coolant passes across and around the excitation source 6 and the lasing medium 5 transverse to their long dimension. The coolant is then received through a second slot 14 formed in first half shell 10 along a second plenum 16 located along the coupling element 2 opposite the first slot 11. Liquid flowing into the second plenum 16 exits the cavity structure through outlet 12.

Referring to FIG. 3, a half shell for a laser cavity structure in accordance with the embodiment is shown with a slot 11 configuration to enable liquid flow into through and out of the cavity as described above, and alternatively with multiple holes 18 formed in the half shell. The holes can be used to individually direct liquid flow within the coupling element 2. The present inventor has found that coolant flow is most effective as a coolant when it is caused to flow transverse to the lasing medium and laser excitation source orientation.

Alternate embodiments, modifications and substitutions by one of ordinary skill in the art of the present invention is within the scope of the present invention which is not to be limited except by the descriptions and claims presented herein.

1. A laser system, comprising;
(a) a laser cavity including two half shells adapted to be held together forming the laser cavity as an integrated structure, said laser cavity adapted for retaining an excitation source and a lasing medium; wherein at least one of said half shells has at least one coolant passage formed therein to cause liquid to flow transversely over the excitation source and lasing medium and at least one of said half shells has at least one coolant passage formed therein to remove liquid from the laser cavity after the liquid is caused to flow transversely over the excitation source and lasing medium.

2. The laser system of claim 1 further comprising a gasket that is compressible between the half shells when closed together forming a coolant seal.

3. The laser system of claim 1 further comprising an inlet formed in at least one of the two half shells, wherein coolant is transported into the laser cavity and through the coolant passages formed therein on at least one half shell prior to the coolant flowing transversely over the excitation source and lasing medium.

4. The laser system of claim 3 further comprising an outlet formed in at least one of the two half shells, wherein coolant is removed from the laser cavity through the outlet and coolant passages formed therein on at least one half shell after the liquid is caused to flow transversely over the excitation source and lasing medium.

5. The laser system of claim 2 further comprising an inlet formed in at least one of the two half shells, wherein coolant is transported into the laser cavity and through the coolant passages formed therein on at least one half shell prior to the coolant flowing transversely over the excitation source and lasing medium.

6. The laser system of claim 5 further comprising an outlet formed in at least one of the two half shells, wherein coolant is removed from the laser cavity through the outlet and coolant passages formed therein on at least one half shell after the liquid is caused to flow transversely over the excitation source and lasing medium.

7. The laser system of claim 4 further comprising a gasket that is compressible between the half shells when closed together forming a coolant seal.

8. The laser system of claim 1 wherein the laser system is used for at least one of: skin resurfacing, wrinkle removal, tattoo removal, surgery.

9. A laser system, comprising;
a laser cavity including two half shells adapted to be held together forming the laser cavity as an integrated structure, said laser cavity adapted for retaining an excitation source and a lasing medium; wherein at least one of said half shells has at least one coolant passage formed therein to cause liquid to flow transversely over the excitation source and lasing medium and at least one of said half shells has at least one coolant passage formed therein to remove liquid from the laser cavity after the liquid is caused to flow transversely over the excitation source and lasing medium;
an inlet formed in at least one of the two half shells, wherein coolant is transported into the laser cavity and through the coolant passages formed therein on at least one half shell prior to the coolant flowing transversely over the excitation source and lasing medium; and
an outlet formed in at least one of the two half shells, wherein coolant is removed from the laser cavity through the outlet and coolant passages formed therein on at least one half shell after the liquid is caused to flow transversely over the excitation source and lasing medium.

10. The laser system of claim 9 further comprising a gasket that is compressible between the half shells when closed together forming a coolant seal.

11. A hand held medical laser, comprising a cavity including two half shells adapted to be closed together forming a seal, said cavity adapted for retaining an excitation source and a lasing medium, wherein at least one of said half shells has at least one coolant passage formed therein to cause liquid to flow transversely over the excitation source and lasing medium and at least one of said half shells has at least one coolant passage formed therein to remove liquid from the cavity after the liquid is caused to flow transversely over the excitation source and lasing medium.

12. The handheld medical laser of claim 11 further comprising a gasket that is compressible between the half shells when closed together forming the seal.

13. The handheld medical laser of claim 11 further comprising an inlet formed in at least one of the two half shells, wherein coolant is transported into the laser cavity and through the coolant passages formed therein on at least one half shell prior to the coolant flowing transversely over the excitation source and lasing medium.

14. The handheld medical laser of claim 13 further comprising an outlet formed in at least one of the two half shells, wherein coolant is removed from the laser cavity through the outlet and coolant passages formed therein on at least one half shell after the liquid is caused to flow transversely over the excitation source and lasing medium.

15. The handheld medical laser of claim 13 further comprising a gasket that is compressible between the half shells when closed together forming the seal.

16. The handheld medical laser of claim 14 further comprising a gasket that is compressible between the half shells when closed together forming the seal.

17. The handheld medical laser of claim 12 further comprising an inlet formed in at least one of the two half shells, wherein coolant is transported into the laser cavity and through the coolant passages formed therein on at least one half shell prior to the coolant flowing transversely over the excitation source and lasing medium.

18. The handheld medical laser of claim 17 further comprising an outlet formed in at least one of the two half shells, wherein coolant is removed from the laser cavity through the outlet and coolant passages formed therein on at least one half shell after the liquid is caused to flow transversely over the excitation source and lasing medium.

19. The handheld medical laser of claim 11 further comprising:
an inlet formed in at least one of the two half shells, wherein coolant is transported into the laser cavity and through the coolant passages formed therein on at least one half shell prior to the coolant flowing transversely over the excitation source and lasing medium; and
an outlet formed in at least one of the two half shells, wherein coolant is removed from the laser cavity through the outlet and coolant passages formed therein on at least one half shell after the liquid is caused to flow transversely over the excitation source and lasing medium.

20. The handheld medical laser of claim 12 further comprising:
an inlet formed in at least one of the two half shells, wherein coolant is transported into the laser cavity and through the coolant passages formed therein on at least one half shell prior to the coolant flowing transversely over the excitation source and lasing medium; and
an outlet formed in at least one of the two half shells, wherein coolant is removed from the laser cavity through the outlet and coolant passages formed therein on at least one half shell after the liquid is caused to flow transversely over the excitation source and lasing medium.
